(19) United States
(12) Patent Application Publication
(10) Pub. No.: US 2025/0203474 A1
(43) Pub. Date: Jun. 19, 2025

(54) SCHEDULING RESTRICTIONS FOR LAYER 1 MEASUREMENTS IN LAYER 1/LAYER 2 INTER-CELL MOBILITY OPERATIONS

(71) Applicant: QUALCOMM Incorporated, San Diego, CA (US)

(72) Inventors: Fang YUAN, Beijing (CN); Yan ZHOU, San Diego, CA (US); Jelena DAMNJANOVIC, Del Mar, CA (US); Changhwan PARK, San Diego, CA (US); Tao LUO, San Diego, CA (US)

(21) Appl. No.: 18/848,732

(22) PCT Filed: May 12, 2022
(86) PCT No.: PCT/CN2022/092426

§ 371 Date: Sep. 19, 2024

(51) Int. Cl. H04W 36/04; H04L 27/26; H04W 24/02; H04W 36/00; H04W 56/00

(52) U.S. Cl. CPC H04W 36/04; H04L 27/26025; H04W 24/02; H04W 36/0058; H04W 36/0088; H04W 56/0015

(57) ABSTRACT

Various aspects of the present disclosure generally relate to wireless communication. In some aspects, a user equipment (UE) may receive a measurement configuration indicating a scheduling restriction corresponding to a Layer 1 (L1) measurement of a reference signal associated with an L1 or Layer 2 (L1/L2) inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal. The UE may receive the reference signal based at least in part on the measurement configuration. Numerous other aspects are described.

### FIELD OF THE DISCLOSURE

Aspects of the present disclosure generally relate to wireless communication and to techniques and apparatuses for scheduling restrictions for Layer 1 measurements in Layer 1/Layer 2 inter-cell mobility operations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to receive a measurement configuration indicating a scheduling restriction corresponding to a Layer 1 (L1) measurement of a reference signal associated with an L1 or Layer 2 (L1/L2) inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal. The one or more processors may be configured to receive the reference signal based at least in part on the measurement configuration.

Some aspects described herein relate to a network node for wireless communication. The network node may include a memory and one or more processors coupled to the memory. The one or more processors may be configured to transmit a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal. The one or more processors may be configured to transmit the reference signal based at least in part on the measurement configuration.

Some aspects described herein relate to a method of wireless communication performed by a UE. The method may include receiving a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal. The method may include receiving the reference signal based at least in part on the measurement configuration.

Some aspects described herein relate to a method of wireless communication performed by a network node. The method may include transmitting a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal. The method may include transmitting the reference signal based at least in part on the measurement configuration.

Some aspects described herein relate to a non-transitory computer-readable medium that stores a set of instructions for wireless communication by a UE. The set of instructions, when executed by one or more processors of the UE, may cause the UE to receive a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal. The set of instructions, when executed by one or more processors of the UE, may cause the UE to receive the reference signal based at least in part on the measurement configuration.

Some aspects described herein relate to a non-transitory computer-readable medium that stores a set of instructions for wireless communication by a network node. The set of instructions, when executed by one or more processors of the network node, may cause the network node to transmit a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal. The set of instructions, when executed by one or more processors of the network node, may cause the network node to transmit the reference signal based at least in part on the measurement configuration.

Some aspects described herein relate to an apparatus for wireless communication. The apparatus may include means for receiving a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal. The apparatus may include means for receiving the reference signal based at least in part on the measurement configuration.

Some aspects described herein relate to an apparatus for wireless communication. The apparatus may include means for transmitting a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal. The apparatus may include means for transmitting the reference signal based at least in part on the measurement configuration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIGS. 4A and 4B are diagrams illustrating examples of Layer 1 (L1) and/or Layer 2 (L1/L2) inter-cell mobility, in accordance with the present disclosure.

FIG. 5 is a diagram illustrating an example associated with scheduling restrictions for L1 measurements in L1/L2 inter-cell mobility operations, in accordance with the present disclosure.

FIGS. 6 and 7 are diagrams illustrating example processes associated with scheduling restrictions for L1 measurements in L1/L2 inter-cell mobility operations, in accordance with the present disclosure.

FIGS. 8 and 9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

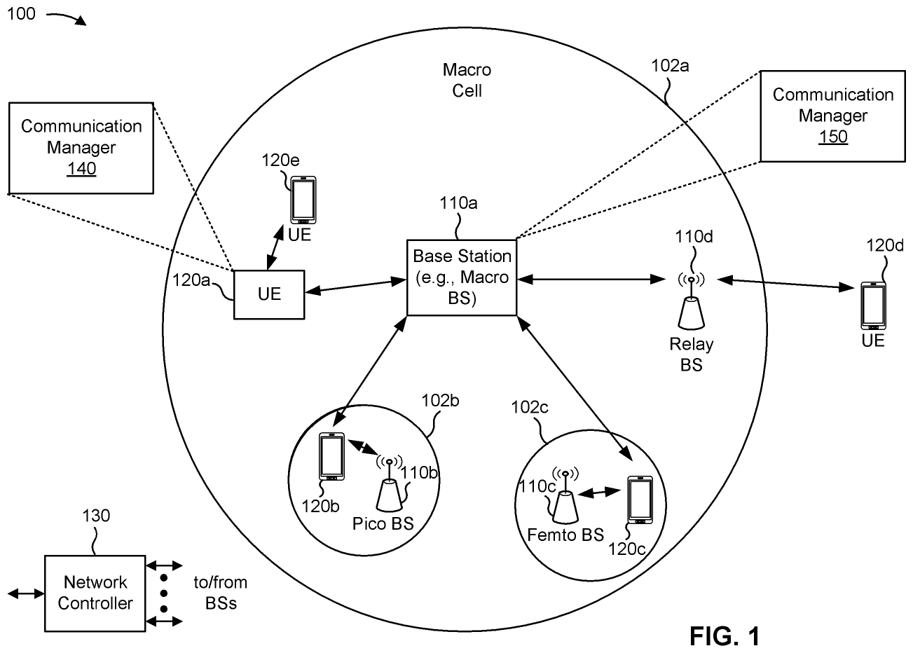

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described herein, a network node, which also may be referred to as a “node” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some aspects, a UE (e.g., the UE 120) may include a communication manager 140. As described in more detail elsewhere herein, the communication manager 140 may receive a measurement configuration indicating a scheduling restriction corresponding to a Layer 1 (L1) measurement of a reference signal associated with an L1 or Layer 2 (L1/L2) inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal;
and receive the reference signal based at least in part on the measurement configuration. Additionally, or alternatively, the communication manager 140 may perform one or more other operations described herein.

In some aspects, a network node may include a communication manager 150. As described in more detail elsewhere herein, the communication manager 150 may transmit a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal; and transmit the reference signal based at least in part on the measurement configuration. Additionally, or alternatively, the communication manager 150 may perform one or more other operations described herein.

As indicated above, FIG. 1 is provided as an example. Other examples may differ from what is described with regard to FIG. 1.

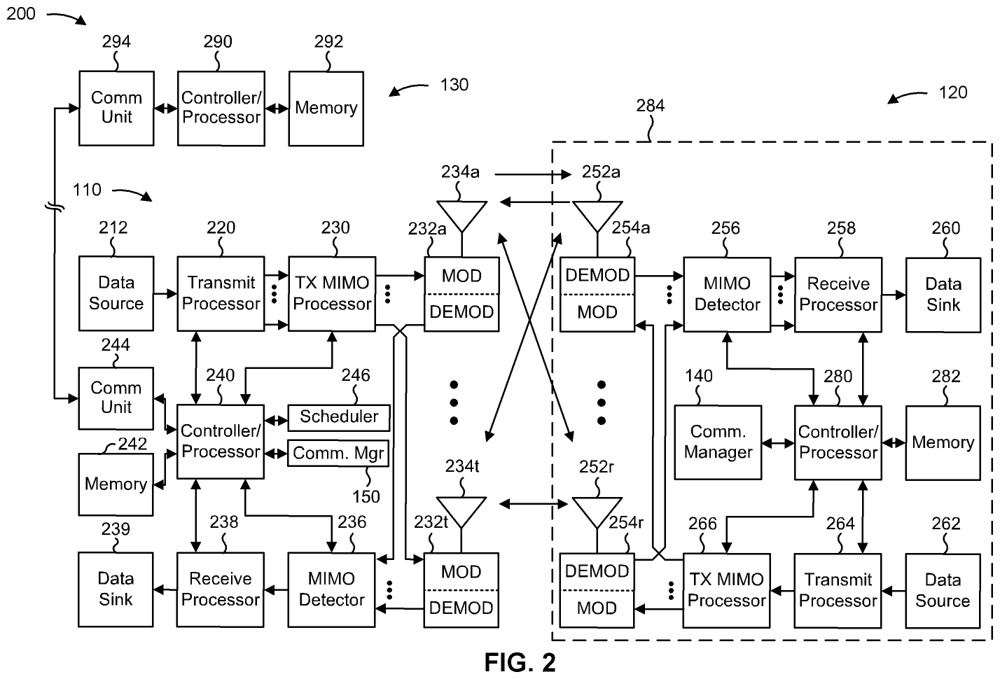

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

In some aspects, the term “base station” (e.g., the base station 110), “network node,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication may be, or include, a TCI state information element, a beam ID, spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateIl)), a quasi-co-location (QCL) type (e.g., a qcl-Type 1, qcl-Type2, qcl-TypeA, qcl-TypeB, qcl-Type (′, qcl-TypeD), and/or the like), a cell identification (e.g., a Serv (′ellIndex), a bandwidth part identification (bwp-ld), a reference signal identification such as a CSI-RS (e.g., an NZP-CSI-RS-Resourceld, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support L1-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI. Wireless communications systems may support the use of various types of unified TCIs. For instance, a first type of unified TCI (e.g., Type 1 TCI) may be used to indicate a common beam for at least one downlink channel or reference signal and for at least one uplink channel or reference signal (e.g., a joint downlink uplink common TCI state). A second type of unified TCI (e.g., Type 2 TCI) may be used to indicate a common beam for more than one downlink channel or reference signal (e.g., a separate downlink common TCI state). A third type of unified TCI (e.g., Type 3 TCI) may be used to indicate a common beam for more than one uplink channel or reference signal (e.g., a separate uplink common TCI state). A fourth type of unified TCI (e.g., Type 4 TCI) may be used to indicate a beam for a single downlink channel or reference signal (e.g., a separate downlink single channel or reference signal TCI). A fifth type of unified TCI (e.g., Type 5 TCI) may be used to indicate a beam for a single uplink channel or reference signal (e.g., a separate uplink single channel or reference signal TCI). A sixth type of unified TCI (e.g., Type 6 TCI) may include uplink spatial relation information to indicate a beam for a single uplink channel or reference signal.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

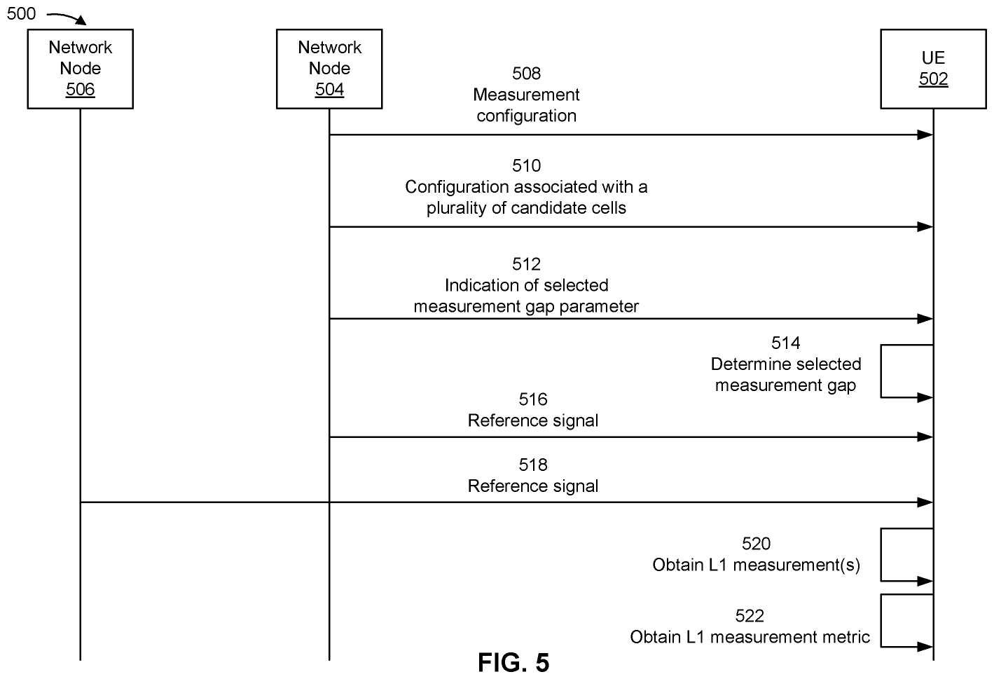

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

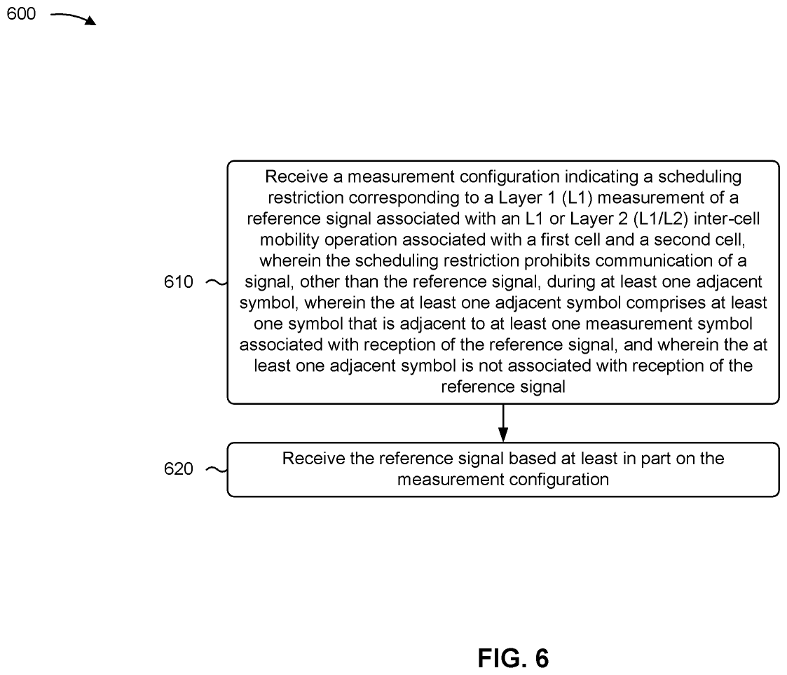

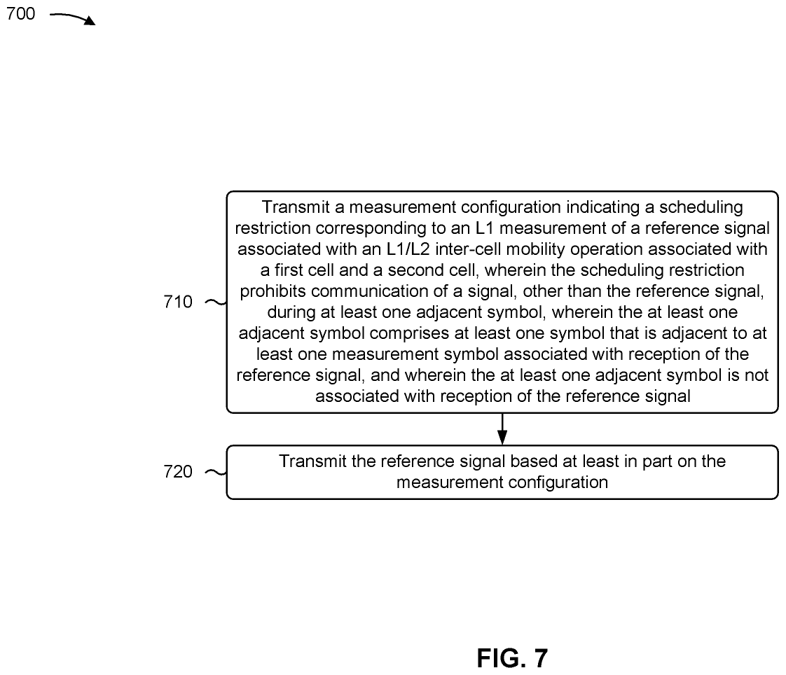

The controller/processor 240 of the base station 110, the controller/processor 280 of the UE 120, and/or any other component(s) of FIG. 2 may perform one or more techniques associated with scheduling restrictions for L1 measurements in L1/L2 inter-cell mobility operations, as described in more detail elsewhere herein. In some aspects, the network node described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE includes means for receiving a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal; and/or means for receiving the reference signal based at least in part on the measurement configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node includes means for transmitting a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal; and/or means for transmitting the reference signal based at least in part on the measurement configuration. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN), also known as a cloud radio access network (C-RAN) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

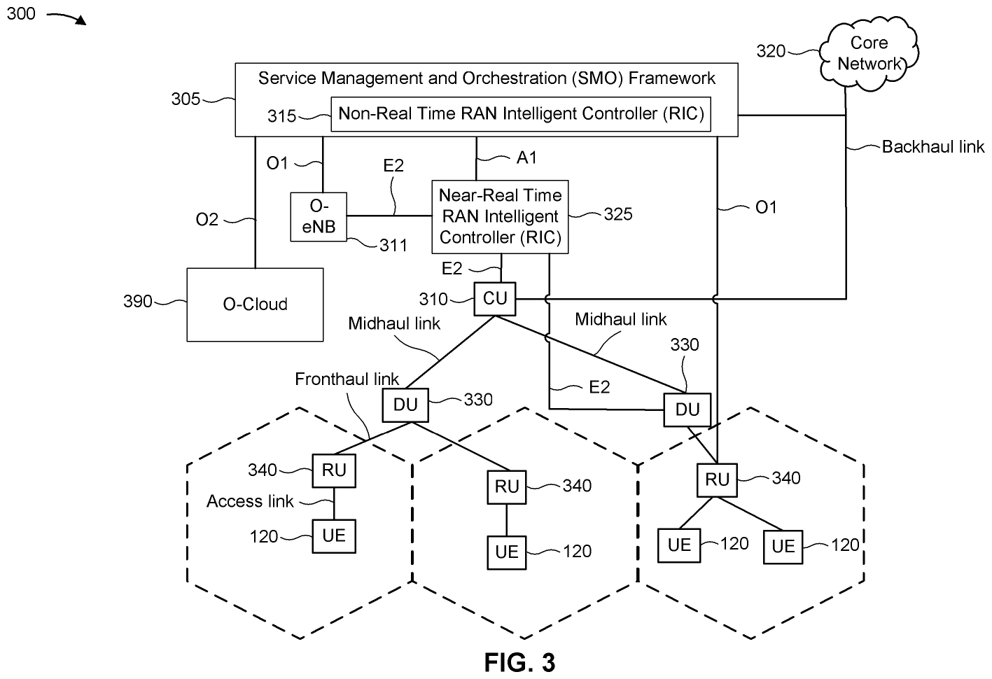

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

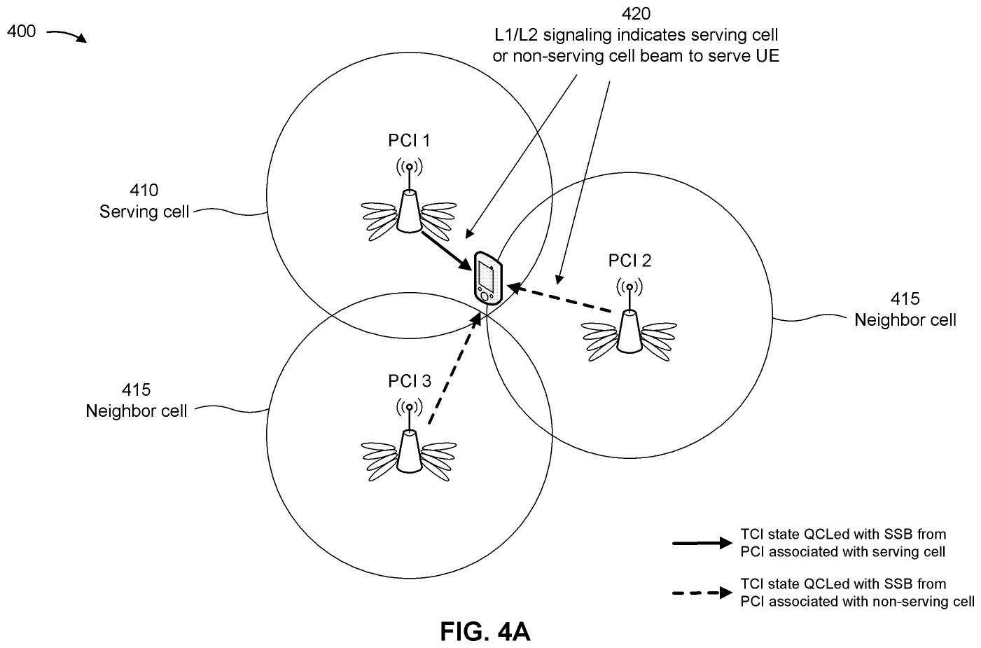

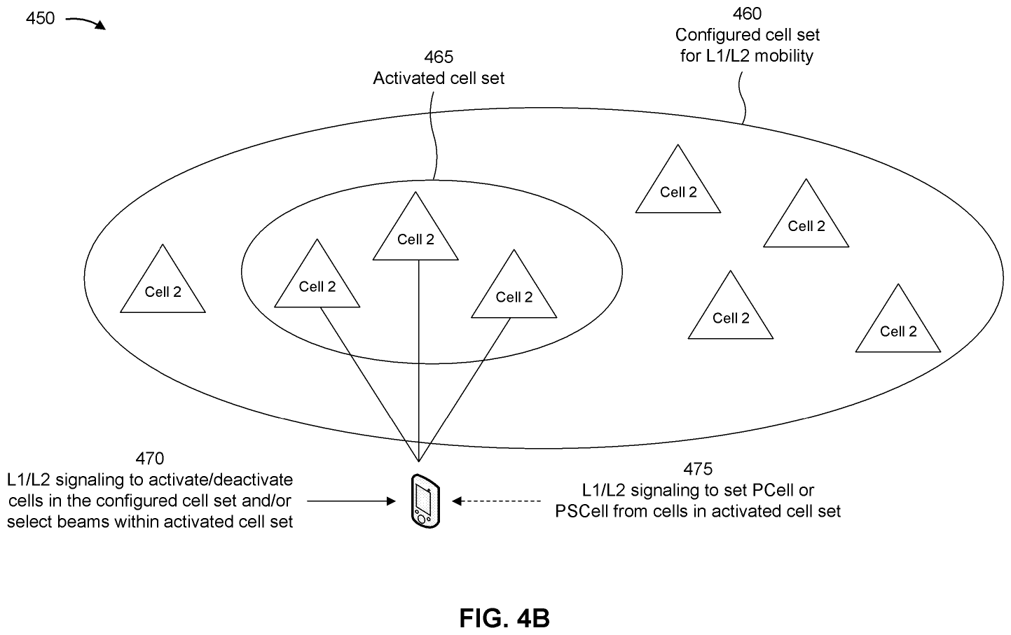

FIGS. 4A-4B are diagrams illustrating examples 400, 450 of L1/L2 inter-cell mobility, in accordance with the present disclosure.

In a wireless network, such as an NR network, a UE and a network node (e.g., a base station or one or more units or components performing base station functionality) may communicate on an access link using directional links (e.g., using high-dimensional phased arrays) to benefit from a beamforming gain and/or to maintain acceptable communication quality. The directional links, however, typically require fine alignment of transmit and receive beams, which may be achieved through a set of operations referred to as beam management and/or beam selection, among other examples. Further, a wireless network may support multi-beam operation in a relatively high carrier frequency (e.g., within FR2), which may be associated with harsher propagation conditions than comparatively lower carrier frequencies. For example, relative to a sub-6 gigahertz (GHz) band, signals propagating in a millimeter wave frequency band may suffer from increased pathloss and severe channel intermittency, and/or may be blocked by objects commonly present in an environment surrounding the UE (e.g., a building, a tree, and/or a body of a user, among other examples). Accordingly, beam management is particularly important for multi-beam operation in a relatively high carrier frequency.

One possible enhancement for multi-beam operation in a higher carrier frequency is facilitation of efficient (e.g., low latency and low overhead) downlink and/or uplink beam management to support higher L1/L2-centric inter-cell mobility. Accordingly, one goal for L1/L2-centric inter-cell mobility is to enable a UE to perform a cell switch via dynamic control signaling at lower layers (e.g., downlink control information (DCI) for L1 signaling or a medium access control (MAC) control element (MAC CE) for L2 signaling) rather than semi-static Layer 3 (L3) RRC signaling in order to reduce latency, reduce overhead, and/or otherwise increase efficiency of the cell switch.

For example, FIG. 4A illustrates an example 400 of a first L1/L2 inter-cell mobility technique, which may be referred to as inter-cell mobility scheme 1, beam-based inter-cell mobility, dynamic point selection based inter-cell mobility, and/or non-serving cell-based inter-cell mobility, among other examples. As described in further detail herein, the first L1/L2 inter-cell mobility technique may enable a network node to use L1 signaling (e.g., DCI) or L2 signaling (e.g., a MAC-CE) to indicate that a UE is to communicate on an access link using a beam from a serving cell or a non-serving cell. For example, in a wireless network where L1/L2 inter-cell mobility is not supported (e.g., cell switches are triggered only by an L3 handover), beam selection for control information and for data is typically limited to beams within a physical cell identifier (PCI) associated with a serving cell. In contrast, in a wireless network that supports the first L1/L2 inter-cell mobility technique (e.g., as shown in FIG. 4A), beam selection for control and data may be expanded to include any beams within a serving cell 410 or one or more non-serving neighbor cells 415 configured for L1/L2 inter-cell mobility.

For example, in the first L1/L2 inter-cell mobility technique shown in FIG. 4A, a UE may be configured with a single serving cell 410, and the UE may be further configured with a neighbor cell set that includes one or more non-serving cells 415 configured for L1/L2 inter-cell mobility. In general, the serving cell 410 and the non-serving cells 415 that are configured for L1/L2 inter-cell mobility may be associated with a common CU and a common DU, or the serving cell 410 and the non-serving cells 415 configured for L1/L2 inter-cell mobility may be associated with a common CU and different DUs. In some aspects, as shown by reference number 420, a base station may trigger L1/L2 inter-cell mobility for a UE using L1/L2 signaling (e.g., DCI or a MAC-CE) that indicates a selected TCI state QCLed with a reference signal (e.g., a synchronization signal block (SSB)) associated with a PCI. For example, in FIG. 4A, the UE may be communicating with the serving cell 410 using a TCI state that is QCLed with an SSB from a PCI associated with the serving cell 410 (e.g., shown as PCI 1 in FIG. 4A), and L1/L2 signaling may trigger inter-cell mobility by indicating that the UE is to switch to communicating using a TCI state that is QCLed with an SSB from a PCI associated with a non-serving neighbor cell 415 (e.g., shown as PCI 2 in FIG. 4A). Accordingly, in the first L1/L2 inter-cell mobility technique, the network node (e.g., the common CU controlling the serving cell 410 and the non-serving neighbor cells 415) may use L1/L2 signaling to select a beam from either the serving cell 410 or a non-serving neighbor cell 415 to serve the UE.

In this way, relative to restricting L1/L2 beam selection to beams within the serving cell 410, the first L1/L2 inter-cell mobility technique may be more robust against blocking and may provide more opportunities for higher rank spatial division multiplexing across different cells. However, the first L1/L2 inter-cell mobility technique does not enable support for changing a primary cell (PCell) or a primary secondary cell (PSCell) for a UE. Rather, in the first L1/L2 inter-cell mobility technique, triggering a PCell or PSCell change is performed via a legacy L3 handover using RRC signaling. In this respect, the first L1/L2 inter-cell mobility technique is associated with a limitation that L1/L2 signaling can only be used to indicate a beam from the serving cell 410 or a configured neighbor cell 415 while the UE is in the coverage area of the serving cell 410 because L1/L2 signaling cannot be used to change the PCell or PSCell. Accordingly, FIG. 4B illustrates an example 450 of a second L1/L2 inter-cell mobility technique, which may be referred to as inter-cell mobility scheme 2 and/or serving cell-based inter-cell mobility, among other examples. As described in further detail herein, the second L1/L2 inter-cell mobility technique may enable a network node to use L1/L2 signaling (e.g., DCI or a MAC-CE) to indicate control information associated with an activated cell set and/or a deactivated cell set and/or to indicate a change to a PCell or a PSCell within the activated cell set.

For example, as shown in FIG. 4B, the second L1/L2 inter-cell mobility technique may use mechanisms that are generally similar to carrier aggregation to enable L1/L2 inter-cell mobility, except that different cells configured for L1/L2 inter-cell mobility may be on the same carrier frequency. As shown in FIG. 4B, a network node may configure a cell set 460 for L1/L2 inter-cell mobility (e.g., using RRC signaling). As further shown, an activated cell set 465 may include one or more cells in the configured cell set 460 that are activated and ready to use for data and/or control transfer. Accordingly, in the second L1/L2 inter-cell mobility technique, a deactivated cell set may include one or more cells that are included in the cell set 460 configured for L1/L2 inter-cell mobility but are not included in the activated cell set 465. However, the cells that are included in the deactivated cell set can be readily activated, and thereby added to the activated cell set 465, using L1/L2 signaling. Accordingly, as shown by reference number 470, L1/L2 signaling can be used for mobility management of the activated cell set 465. For example, in some aspects, L1/L2 signaling can be used to activate cells within the configured cell set 460 (e.g., to add cells to the activated cell set 465), to deactivate cells in the activated cell set 465, and/or to select beams within the cells included in the activated cell set 465. In this way, the second L1/L2 inter-cell mobility technique may enable seamless mobility among the cells included in the activated cell set 465 using L1/L2 signaling (e.g., using beam management techniques).

Furthermore, as shown by reference number 475, the second L1/L2 inter-cell mobility technique enables using L1/L2 signaling to set or change a PCell or PSCell from the cells that are included in the activated cell set 465. Additionally, or alternatively, when the cell to become the new PCell or PSCell is in the deactivated cell set (e.g., is included in the cell set 460 configured for L1/L2 mobility but not the activated cell set 465), L1/L2 signaling can be used to move the cell from the deactivated cell set to the activated cell set 465 before further L1/L2 signaling is used to set the cell as the new PCell or PSCell. However, in the second L1/L2 inter-cell mobility techniques, an L3 handover (using RRC signaling) is used to change the PCell or PSCell when the new PCell or PSCell is not included in the cell set 460 configured for L1/L2 inter-cell mobility. In such cases, RRC signaling associated with the L3 handover may be used to update the cells included in the cell set 460 that is configured for L1/L2 inter-cell mobility.

In some cases, an L1-RSRP measurement scheduling restriction rule can be implemented for FR1. In accordance with the rule, a UE will not transmit or receive on symbols associated with an SSB configured for L1-RSRP measurement if the SSB has a subcarrier spacing (SCS) different from an associated physical downlink control channel (PDCCH) and/or PDSCH, and the UE does not support simultaneous reception of data and SSBs having different numerologies. For UEs that do support simultaneous reception of data and SSBs having different numerologies, there are no restrictions on scheduling availability due to L1-RSRP measurement based on the an SSB being configured as a reference signal for L1-RSRP measurement. For UEs that do not support simultaneous reception of data and SSBs having different numerologies, a number of different restrictions can apply with respect to L1-RSRP measurement based on an SSB being configured for L1-RSRP measurement.

For example, one restriction can establish that the UE is not expected to transmit physical uplink control channel (PUCCH) signals, physical uplink shared channel (PUSCH) signals, or SRSs or receive PDCCH signals, PDSCH signals, or channel state information (CSI)-reference signals (CSI-RSs) for tracking or CSI-RSs for CQI on symbols corresponding to the SSB indexes configured for L1-RSRP measurement. Another restriction can establish that, when intra-band carrier aggregation in FR1 is configured, the scheduling restrictions on the serving cell where L1-RSRP measurement is performed apply to all serving cells in the same band on the symbols that fully or partially overlap with restricted symbols. In some cases, when inter-band carrier aggregation within FR1 is configured, there are no scheduling restrictions on FR1 serving cell(s) configured in other bands than the bands in which the serving cell where L1-RSRP measurement is performed is configured. In some cases, a restriction rule may establish that, for FR2, a UE will not transmit on symbols of DL reference signals for L1-RSRP measurement, and the restriction rule indicates that the UE can receive on those symbols only if the DL RS is CSI-RS QCLed with PDCCH/PDSCH active TCI and not in a CSI-RS resource set with repetition on.

In some cases, for the case where an RS for L1-RSRP measurement is a CSI-RS which is QCLed with an active TCI state for PDCCH/PDSCH, and not in a CSI-RS resource set with repetition ON, and N=1, there are no scheduling restrictions due to L1-RSRP measurement performed based on the CSI-RS. The rule can specify that, otherwise, the UE is not expected to transmit PUCCH signals, PUSCH signals, or SRSs, or receive PDCCH signals, PDSCH signals, CSI-RSs for tracking, or CSI-RSs for CQI on symbols corresponding to the SSB indexes configured for L1-RSRP measurement, symbols corresponding to the periodic CSI-RS resource configured for L1-RSRP measurement, symbols corresponding to the semi-persistent CSI-RS resource configured for L1-RSRP measurement when the resource is activated, and/or symbols corresponding to the aperiodic CSI-RS resource configured for L1-RSRP measurement when the reporting is triggered.

The L1 measurement scheduling restriction rules described above do not accommodate the following scenarios, which can occur in association with L1/L2 based mobility. In a first scenario, a measured DL RS can be from a neighbor cell, which can be DL synchronized or asynchronous with the serving cell. Two cells are DL synchronized when the DL frame transmission timing is aligned between the two cells. For both DL synchronized and asynchronous cells, the RS reception timing from a neighbor cell can be different from the serving cell reception timing (e.g., reception timing difference>1 cyclic prefix (CP)). The scheduling rules described above also do not consider the misaligned reception timing.

In a second scenario, a measured RS from a neighbor cell can be either intra-frequency or inter-frequency. A measurement gap can be used for inter-frequency measurement if the measured RS is outside of a current active DL bandwidth part (BWP). In a third scenario, measured SSBs from a neighbor cell and a serving cell can overlap. The SSBs may have different SCS and different QCL-TypeD configurations.

Some aspects described herein provide techniques and apparatuses for scheduling restrictions for L1 measurements in L1/L2 inter-cell mobility operations. For example, a UE may receive a measurement configuration indicating a scheduling restriction corresponding to an L1 measurement of a reference signal associated with an L1/L2 inter-cell mobility operation associated with a first cell and a second cell. For example, the first cell may be a source cell (e.g., a serving cell), and the second cell may be a target cell. The scheduling restriction may prohibit communication of a signal, other than the reference signal, during at least one adjacent symbol. The at least one adjacent symbol may include at least one symbol that is adjacent to at least one measurement symbol associated with reception of the reference signal, but which is not associated with reception of the reference signal. The UE may receive the reference signal based at least in part on the measurement configuration. In this way, the UE may support L1 measurement restrictions for L1/L2 inter-cell mobility, which may enable accommodation, for example, of scenarios such as the three scenarios described herein. In this way, some aspects may facilitate mitigation of potential interference, and an increased likelihood of accomplishing L1 measurement despite timing differences between source cells and target cells, thereby positively impacting network performance.

As indicated above, FIGS. 4A-4B are provided as examples. Other examples may differ from what is described with regard to FIGS. 4A-4B.

FIG. 5 is a diagram illustrating an example 500 associated with scheduling restrictions for L1 measurements in L1/L2 inter-cell mobility operations, in accordance with the present disclosure. As shown in FIG. 5, a UE 502 may communicate with a network node 504 and a network node 506. The UE 502 may be, be similar to, include, or be included in, the UE 120 depicted in FIGS. 1 and 2. The network node 504 and/or the network node 506 may be, be similar to, include, or be included in the base station 110 depicted in FIGS. 1 and 2, and/or one or more components of the disaggregated base station architecture 300 depicted in FIG. 3.

As shown by reference number 508, the network node 504 may transmit, and the UE 502 may receive a measurement configuration. The measurement configuration may indicate a scheduling restriction corresponding to an L1 measurement of a reference signal associated with an L1/L2 inter-cell mobility operation associated with a first cell and a second cell. The scheduling restriction may prohibit communication of a signal, other than the reference signal, during at least one adjacent symbol. The at least one adjacent symbol may include at least one symbol that is adjacent to at least one measurement symbol associated with reception of the reference signal. The at least one adjacent symbol is not associated with reception of the reference signal. For example, a range of symbols applicable to a scheduling restriction rule may be extended to account for different reception timing between a measured cell and a serving cell, rather than restricting the scheduling only on symbols associated with the measured downlink reference signal.

In some aspects, the at least one adjacent symbol may include at least one indication that indicates a first set of symbols occurring immediately before the at least one measurement symbol and a second set of symbols occurring immediately after the at least one measurement symbol. The measurement configuration may include at least one of a first indication of a first quantity of symbols in the first set of symbols or a second indication of a second quantity of symbols in the second set of symbols. In some aspects, the first quantity of symbols is equal to the second quantity of symbols. For example, in some aspects, a scheduling restriction may establish that a UE is not expected to transmit PUCCH signals, PUSCH signals, or SRSs or receive PDCCH signals, PDSCH signals, tracking reference signals (TRSs), or CSI-RSs for CQI on DL RS symbols to be measured, and on X data symbols before each consecutive DL RS symbols to be measured and X data symbols after each consecutive DL RS symbols to be measured. The scheduling restriction may restrict scheduling within a measurement window duration. In some aspects, the first quantity of symbols (e.g., X) may include a configured value. In some aspects, the first quantity of symbols may be based at least in part on at least one SCS of a downlink BWP part associated with the reference signal or a frequency range (e.g., FR1 or FR2) associated with the reference signal. In some aspects, the at least one adjacent symbol may include at least one data symbol. This scheduling restriction may be applied when cells are synchronized, e.g., when the parameter deriveSSB-IndexFromCell is enabled for the measured frequency.

In some aspects, the scheduling restriction may correspond to at least a portion of a measurement window duration. For example, in some aspects, a scheduling restriction may establish that a UE is not expected to transmit PUCCH signals, PUSCH signals, or SRSs or receive PDCCH signals, PDSCH signals, TRSs, or CSI-RSs for CQI on all symbols within a measurement window duration. This restriction may be applied when cells are not synchronized, e.g., when the parameter deriveSSB-IndexFromCell is disabled for the measured frequency. The at least the portion of the measurement window duration may include a portion of the measurement window duration that is less than an entire measurement window duration. In some aspects, the first cell may be synchronized with the second cell, and an SSB index associated with the second cell may correspond to an SSB index associated with the first cell. In some aspects, the scheduling restriction may correspond to an entire measurement window duration. For example, the scheduling restriction may correspond to at least a portion of a measurement window duration in cases in which the source cell and target cell are synchronized (e.g., when the parameter deriveSSB-IndexFromCell is enabled for the measured frequency). In some other aspects, the first cell may be asynchronized (which may be alternatively referred to as “asynchronous”) with the second cell, and an SSB index associated with the second cell may not correspond to an SSB index associated with the first cell.

In some aspects, the measurement window duration may correspond to at least one of a synchronization signal/physical broadcast channel block measurement timing configuration (SMTC) window or a measurement gap window. In some aspects, the reference signal may include an SSB associated with a neighbor cell, and the measurement window duration may correspond to the SMTC window. This rule may be applied for synchronized and/or asynchronized serving and neighbor cells. In some aspects, the first cell may include a serving cell and the second cell may include a neighbor cell. The reference signal may include at least one of an SSB configured for the neighbor cell, a CSI-RS configured for the neighbor cell, or a CSI-RS configured for the serving cell, where the SSB of the neighbor cell provides a QCL source reference signal for the CSI-RS configured for the serving cell. The SSBs from a neighbor cell for L1 measurement may be configured within the SMTC window.

The scheduling restriction may apply in cases in which the reference signal may be associated with a first SCS, where the reference signal overlaps an additional reference signal associated with a second SCS that is different than the first SCS, and the UE 502 does not support simultaneous reception of the reference signal and the additional reference signal. The scheduling restriction also may be applied in cases in which the reference signal is associated with a first reception beam and overlaps an additional reference signal associated with a second reception beam that is different than the first reception beam, and where the UE does not support simultaneous reception of the reference signal and the additional reference signal. For example, the scheduling restriction also may be applied if the reference signal is a CSI-RS not QCLed with an active TCI for a PDCCH signal or a PDSCH signal, or is a CSI-RS in a CSI-RS resource set with repetition “ON.”

In some aspects, the scheduling restriction may be applied without a measurement gap. In some other aspects, the scheduling restriction may be applied with a measurement gap. For example, the scheduling restriction may be applied with the measurement gap based at least in part on the reference signal being outside of an active downlink BWP. In some aspects, the scheduling restriction may be applied with the measurement gap based at least in part on an active downlink BWP associated with the reference signal being different from an initial downlink BWP. In some aspects, the reference signal may correspond to a first SCS, and the scheduling restriction may be applied with the measurement gap based at least in part on the first SCS being different from a second SCS corresponding to an active BWP where the UE does not support simultaneous reception of signals with different SCSs.

As shown by reference number 510, the network node 504 may transmit, and the UE 502 may receive, a configuration associated with a plurality of candidate cells for the L1/L2 inter-cell mobility operation. The measurement configuration may indicate a set of measurement gap configurations for L1 measurements associated with the plurality of candidate cells. For example, when the UE 502 is configured with multiple candidate cells as candidate PCells for L1/L2 based mobility purpose, a set of measurement gap configurations may be configured by RRC signaling for L1 measurement for each candidate cell, and UE measurements for the candidate cell may be dynamically adjusted.

As shown by reference number 512, the network node 504 may transmit, and the UE 502 may receive, an indication of a selected measurement gap configuration associated with a set of measurement gap configurations. For example, the UE 502 may support dynamic measurement gap configuration selection (e.g. upon L1/L2 based cell group mobility/switching). The UE 502 may receive the indication of the selected measurement gap configuration based on receiving at least one of a MAC CE or a DCI transmission. In some aspects, for example, the MAC CE may indicate a subset of measurement gap configurations, of the set of measurement gap configurations, associated with a candidate cell of the plurality of candidate cells. The DCI transmission may indicate a measurement gap configuration of the subset of measurement gap configurations. In some aspects, the MAC CE may indicate only one measurement gap configuration, of the set of measurement gap configuration, as an active measurement gap configuration associated with a candidate cell of the plurality of candidate cells.

As shown by reference number 514, the UE 502 may determine a selected measurement gap configuration, of the set of measurement gap configurations, based at least in part on a measurement gap parameter, corresponding to the selected measurement gap configuration, satisfying an implicit condition. For example, an implicit rule may be used to select one of RRC configured parameters for measurement gaps. In some aspects, the measurement gap parameter may include a measurement gap configuration identifier (ID), and the measurement gap parameter may satisfy the implicit condition based at least in part on the measurement gap configuration ID having a minimum value of a plurality of values corresponding to a plurality of measurement gap configuration IDs associated with the set of measurement gaps.

As shown by reference number 516, the network node 504 may transmit, and the UE 502 may receive, a reference signal. In some aspects, the reference signal may include, for example, an SSB, a CSI-RS, and/or a DMRS, among other examples. As shown by reference number 518, the network node 506 may transmit, and the UE 502 may receive, a reference signal. In some aspects, the reference signal may include, for example, an SSB, a CSI-RS, and/or a DMRS, among other examples.

As shown by reference number 520, the UE 502 may obtain one or more L1 measurements. For example, the UE 502 may obtain one or more L1 measurements associated with the reference signal transmitted by the network node 504 and/or the reference signal transmitted by network node 506. In some aspects, the L1 measurement may include at least one of an intra-frequency L1 measurement or an inter-frequency L1 measurement. In some aspects, the L1 measurement may correspond to at least one of a time division duplexing (TDD) band or a frequency division duplexing (FDD) band. The L1 measurement may correspond to at least one of a first frequency range (e.g., FR1), a second frequency range (e.g., FR2), a third frequency range (e.g., FR2-1), or a fourth frequency range (e.g., FR2-2).

In some aspects, the UE 502 may obtain a measurement corresponding to the reference signal based at least in part on receiving the reference signal during a configured time period. For example, the configured time period may include an overlap, in a time domain, of a measurement gap and a switching period. For example, when measurement gaps are configured, the scheduling restriction may establish that a UE is not expected to detect and/or measure a reference signal that starts earlier than the gap starting time plus a switching time, nor detect and/or measure a reference signal that ends later than the gap end minus the switching time. The switching time may be configured by the network node 504, based on a capability of the UE 502, and/or specified in a wireless communication standard. For example, in some aspects, the switching time may be 0.5 milliseconds (ms) for frequency range FR1 and 0.25 ms for frequency range FR2.

In some aspects, the UE 502 may obtain a first L1 measurement associated with the reference signal, where the reference signal includes a first SSB, and a second L1 measurement associated with a second SSB that overlaps the first SSB based at least in part on the second SSB satisfying an overlap measurement condition. In some aspects, the overlap measurement condition may correspond to a capability of the UE 502. For example, whether the UE 502 can measure overlapped SSBs for L1 measurement may be based on a UE capability or a fixed rule. In some aspects, the first SSB may correspond to a first SCS, the second SSB may correspond to a second SCS, and the second SSB may satisfy an overlap measurement condition based at least in part on the second SCS being different from the first SCS. The second SSB may satisfy the overlap measurement condition based at least in part on a QCL associated with the first SSB and the second SSB being unknown.

In some aspects, the UE 502 may obtain an L1 measurement associated with a measured SSB of the first SSB and the second SSB based at least in part on a first priority of the measured SSB being greater than a second priority of an unmeasured SSB of the first SSB and the second SSB. In some aspects, the first priority may be greater than the second priority based at least in part on the first priority corresponding to a serving cell. In some aspects, the first priority may be greater than the second priority based at least in part on the first priority corresponding to a non-serving cell. In some aspects, the first priority may correspond to a first cell having a first PCI, and the second priority may correspond to a second cell having a second PCI. The first priority may be greater than the second priority based at least in part on the first PCI being greater than, or less than, the second PCI.

In some aspects, the first priority may correspond to a first communication failure function, the second priority may correspond to a second communication failure function, and the first priority may be greater than the second priority based at least in part on the first priority corresponding to the first communication failure function. In some aspects, the first priority may be greater than the second priority based at least in part on the first priority corresponding to a communication failure function, and the second priority not corresponding to a communication failure function. A communication failure function may include, for example, a beam failure function and/or a link failure recovery function, a beam failure determination (BFD) reference signal, a new beam identification (NBI) reference signal, and/or a radio link monitoring (RLM) reference signal, among other examples.

In some aspects, the reference signal may correspond to a first component carrier, and the UE 502 may communicate a signal (e.g., an uplink or downlink data signal) corresponding to a second component carrier that is different from the first component carrier. The first component carrier and the second component carrier may both be associated with a band or a band combination. Common beam management may be used to separate the beams between the component carriers. In some aspects, the first cell and the second cell may be synchronized based at least in part on an alignment, between the first cell and the second cell, of at least one cell feature. The at least one cell feature may include, for example, at least one of a downlink frame transmission boundary, a downlink slot transmission boundary, or a downlink symbol transmission boundary. In some aspects, the first cell and the second cell may be synchronized based at least in part on a timing difference between the first cell and the second cell satisfying a timing difference threshold. For example, when two cells are synchronized, the downlink frame, slot, and/or symbol transmission boundary may be aligned between the two cells (e.g. when deriveSSB-IndexFromCell is enabled for the measured frequency of the neighbor cell). In another example, when two cells are synchronized, the downlink and/or uplink timing difference from and/or to the two cells may be within a threshold (e.g. downlink reception timing difference for the two cells may be less than the duration of a cyclic prefix in OFDM symbols, and a single timing advance value may be applied for both cells in uplink).

In some aspects, the UE 502 may obtain a plurality of L1 measurements based at least in part on a UE capability. The UE capability may be associated with at least one of a maximum quantity of identified cells, a maximum quantity of SSB indices corresponding to an intra-frequency layer, a maximum quantity of SSB indices corresponding to an inter-frequency layer, a maximum quantity of PCIs corresponding to an intra-frequency layer, a maximum quantity of PCIs corresponding to an inter-frequency layer, or a maximum quantity of SSBs per identified cell of the identified cells. For example, the scheduling restriction may indicate that for one single intra-frequency or inter-frequency layer in a band in FR1, FR2-1, or FR2-2, during each L1 measurement period, the UE 502 shall be capable of performing L1-RSRP, L1-RSRQ, and L1-SINR measurements for at least: X identified cells, and Y SSBs with different SSB index and/or PCI on the intra-frequency or inter-frequency layer Z SSB(s) per identified cell.

As shown by reference number 522, the UE 502 may obtain an L1 measurement metric corresponding to the L1 measurement. The L1 measurement metric may include at least one of an RSRP, a signal-to-interference-plus-noise ratio (SINR), or an RSRQ, among other examples.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 502) performs operations associated with scheduling restrictions for L1 measurements in L1/L2 inter-cell mobility operations.

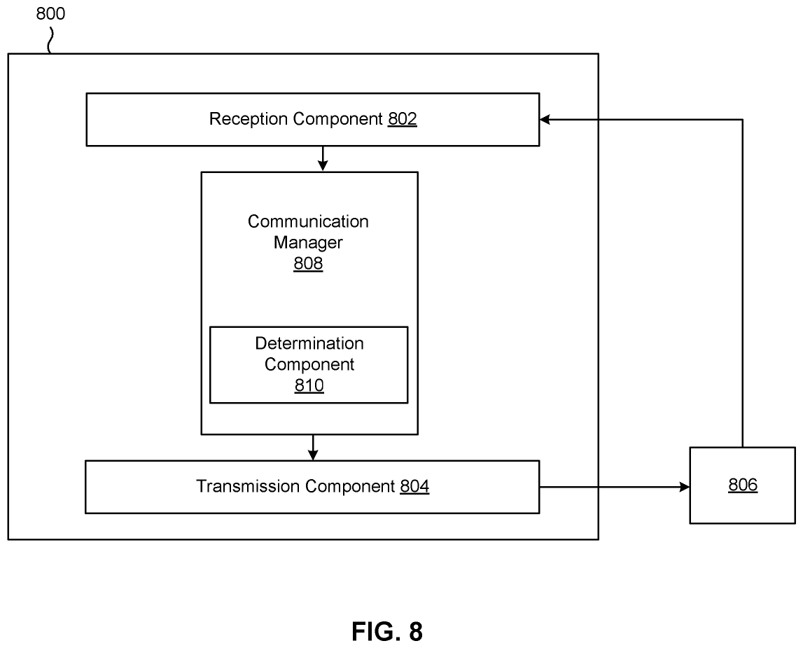

As shown in FIG. 6, in some aspects, process 600 may include receiving a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal (block 610). For example, the UE (e.g., using communication manager 808 and/or reception component 802, depicted in FIG. 8) may receive a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal, as described above.

As further shown in FIG. 6, in some aspects, process 600 may include receiving the reference signal based at least in part on the measurement configuration (block 620). For example, the UE (e.g., using communication manager 808 and/or reception component 802, depicted in FIG. 8) may receive the reference signal based at least in part on the measurement configuration, as described above.

Process 600 may include additional aspects, such as any single aspect or any combination of aspects described below and/or in connection with one or more other processes described elsewhere herein.

In some aspects, the at least one adjacent symbol comprises at least one indication that indicates a first set of symbols occurring immediately before the at least one measurement symbol and a second set of symbols occurring immediately after the at least one measurement symbol. In some aspects, the measurement configuration comprises at least one of a first indication of a first quantity of symbols in the first set of symbols or a second indication of a second quantity of symbols in the second set of symbols. In some aspects, the first quantity of symbols is equal to the second quantity of symbols. In some aspects, the first quantity of symbols comprises a configured value. In some aspects, the first quantity of symbols is based at least in part on at least one of a downlink bandwidth part subcarrier spacing associated with the reference signal or a frequency range associated with the reference signal. In some aspects, the at least one adjacent symbol comprises at least one data symbol. In some aspects, the scheduling restriction corresponds to at least a portion of a measurement window duration. In some aspects, the at least the portion of the measurement window duration comprises a portion of the measurement window duration that is less than an entire measurement window duration.

In some aspects, the first cell is synchronized with the second cell, and wherein an SSB index associated with the second cell corresponds to an SSB index associated with the first cell. In some aspects, the at least the portion of the measurement window duration comprises an entire measurement window duration. In some aspects, the first cell is asynchronized with the second cell, and wherein an SSB index associated with the second cell does not correspond to an SSB index associated with the first cell. In some aspects, the measurement window duration corresponds to at least one of an SMTC window or a measurement gap window. In some aspects, the reference signal comprises an SSB associated with a neighbor cell, and wherein the measurement window duration corresponds to the SMTC window. In some aspects, the first cell comprises a serving cell and the second cell comprises a neighbor cell, and wherein the reference signal comprises at least one of an SSB configured for the neighbor cell, a CSI-RS configured for the neighbor cell, or a CSI-RS configured for the serving cell, wherein the SSB of the neighbor cell provides a QCL source reference signal for the CSI-RS configured for the serving cell.

In some aspects, the L1 measurement comprises at least one of an intra-frequency L1 measurement or an inter-frequency L1 measurement. In some aspects, the L1 measurement corresponds to at least one of a time division duplexing band or a frequency division duplexing band. In some aspects, the L1 measurement corresponds to at least one of a first frequency range, a second frequency range, a third frequency range, or a fourth frequency range. In some aspects, the reference signal is associated with a first subcarrier spacing, wherein the reference signal overlaps an additional reference signal associated with a second subcarrier spacing that is different than the first subcarrier spacing, and wherein the UE does not support simultaneous reception of the reference signal and the additional reference signal. In some aspects, the reference signal is associated with a first reception beam, wherein the reference signal overlaps an additional reference signal associated with a second reception beam that is different than the first reception beam, and wherein the UE does not support simultaneous reception of the reference signal and the additional reference signal.

In some aspects, process 600 includes obtaining an L1 measurement metric corresponding to the L1 measurement, the L1 measurement metric comprising at least one of a reference signal received power, a signal-to-interference-plus-noise ratio, or a reference signal received quality. In some aspects, the scheduling restriction is not applied with a measurement gap. In some aspects, the scheduling restriction is applied with a measurement gap. In some aspects, the scheduling restriction is applied with the measurement gap based at least in part on the reference signal being outside of an active downlink bandwidth part.

In some aspects, the scheduling restriction is applied with the measurement gap based at least in part on an active downlink BWP associated with the reference signal being different from an initial BWP. In some aspects, the reference signal corresponds to a first subcarrier spacing, and wherein the scheduling restriction is applied with the measurement gap based at least in part on the first subcarrier spacing being different from a second subcarrier spacing corresponding to an active bandwidth part. In some aspects, process 600 includes obtaining a measurement corresponding to the reference signal based at least in part on receiving the reference signal during a configured time period, wherein the configured time period comprises an overlap, in a time domain, of the measurement gap and a switching period.

In some aspects, process 600 includes receiving a configuration associated with a plurality of candidate cells for the L1/L2 inter-cell mobility operation, wherein the measurement configuration indicates a set of measurement gap configurations for L1 measurements associated with the plurality of candidate cells. In some aspects, process 600 includes receiving an indication of a selected measurement gap configuration associated with the set of measurement gap configurations. In some aspects, receiving the indication of the selected measurement gap configuration comprises receiving at least one of a MAC CE or a DCI transmission. In some aspects, the MAC CE indicates a subset of measurement gap configurations, of the set of measurement gap configurations, associated with a candidate cell of the plurality of candidate cells. In some aspects, the DCI transmission indicates a measurement gap configuration of the subset of measurement gap configurations.

In some aspects, the MAC CE indicates only one measurement gap configuration, of the set of measurement gap configurations, as an active measurement gap configuration associated with a candidate cell of the plurality of candidate cells. In some aspects, alone or in combination with one or more of the first through thirty-second aspects, process 600 includes determining a selected measurement gap configuration, of the set of measurement gap configurations, based at least in part on a measurement gap parameter, corresponding to the selected measurement gap configuration, satisfying an implicit condition. In some aspects, the measurement gap parameter comprises a measurement gap configuration ID, and wherein the measurement gap parameter satisfies the implicit condition based at least in part on the measurement gap configuration ID having a minimum value of a plurality of values corresponding to a plurality of measurement gap configuration IDs associated with the set of measurement gap configurations.

In some aspects, process 600 includes obtaining a first L1 measurement associated with the reference signal, wherein the reference signal comprises a first SSB, and obtaining a second L1 measurement associated with a second SSB that overlaps the first SSB based at least in part on the second SSB satisfying an overlap measurement condition. In some aspects, the overlap measurement condition corresponds to a capability of the UE. In some aspects, the first SSB corresponds to a first SCS and the second SSB corresponds to a second SCS, and wherein the second SSB satisfies the overlap measurement condition based at least in part on the second SCS being different from the first SCS. In some aspects, the second SSB satisfies the overlap measurement condition based at least in part on a QCL associated with the first SSB and the second SSB being unknown.

In some aspects, the reference signal comprises a first SSB, the method further comprising receiving a second SSB that overlaps the first SSB, and obtaining an L1 measurement associated with a measured SSB of the first SSB and the second SSB based at least in part on a first priority of the measured SSB being greater than a second priority of an unmeasured SSB of the first SSB and the second SSB. In some aspects, the first priority is greater than the second priority based at least in part on the first priority corresponding to a serving cell. In some aspects, the first priority is greater than the second priority based at least in part on the first priority corresponding to a non-serving cell.

In some aspects, the first priority corresponds to a first cell having a first PCI and the second priority corresponds to a second cell having a second PCI, wherein the first priority is greater than the second priority based at least in part on the first PCI being greater than the second PCI. In some aspects, the first priority corresponds to a first cell having a first PCI and the second priority corresponds to a second cell having a second PCI, wherein the first priority is greater than the second priority based at least in part on the first PCI being less than the second PCI. In some aspects, the first priority corresponds to a first communication failure function and the second priority corresponds to a second communication failure function, wherein the first priority is greater than the second priority based at least in part on the first priority corresponding to the first communication failure function.

In some aspects, the reference signal corresponds to a first component carrier, the method further comprising communicating a signal corresponding to a second component carrier that is different from the first component carrier. In some aspects, the first component carrier and the second component carrier are both associated with a band or a band combination. In some aspects, the first cell and the second cell are synchronized. In some aspects, the first cell and the second cell are synchronized based at least in part on an alignment, between the first cell and the second cell, of at least one cell feature, the at least one cell feature comprising at least one of a downlink frame transmission boundary, a downlink slot transmission boundary, or a downlink symbol transmission boundary.

In some aspects, the first cell and the second cell are synchronized based at least in part on a timing difference between the first cell and the second cell satisfying a timing difference threshold. In some aspects, process 600 includes obtaining a plurality of L1 measurements based at least in part on a UE capability associated with at least one of a maximum quantity of identified cells, a maximum quantity of SSB indices corresponding to an intra-frequency layer, a maximum quantity of SSB indices corresponding to an inter-frequency layer, a maximum quantity of PCIs corresponding to an intra-frequency layer, a maximum quantity of PCIs corresponding to an inter-frequency layer, or a maximum quantity of SSBs per identified cell of the identified cells.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 504) performs operations associated with scheduling restrictions for L1 measurements in L1/L2 inter-cell mobility operations.

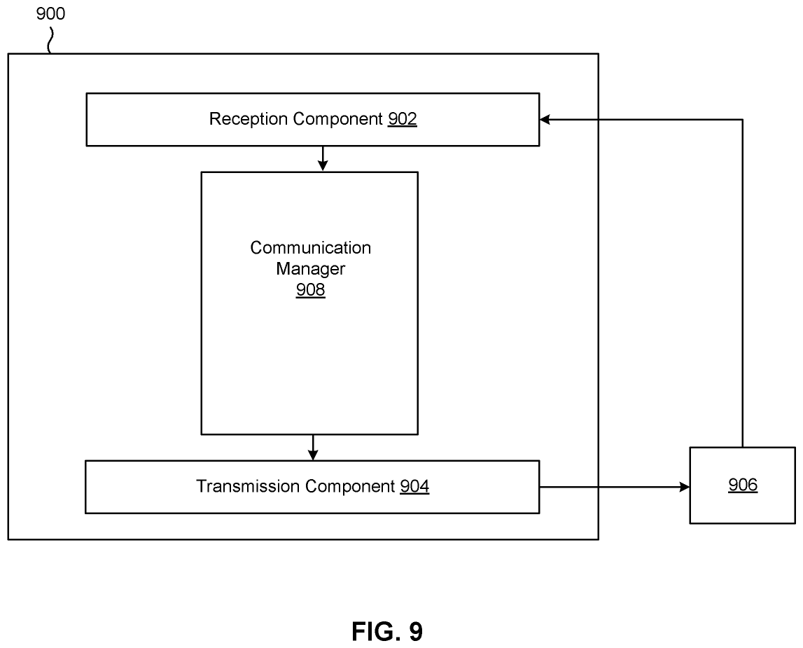

As shown in FIG. 7, in some aspects, process 700 may include transmitting a measurement configuration indicating a scheduling restriction corresponding to L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal (block 710). For example, the network node (e.g., using communication manager 908 and/or transmission component 904, depicted in FIG. 9) may transmit a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal, as described above.

As further shown in FIG. 7, in some aspects, process 700 may include transmitting the reference signal based at least in part on the measurement configuration (block 720). For example, the network node (e.g., using communication manager 908 and/or transmission component 904, depicted in FIG. 9) may transmit the reference signal based at least in part on the measurement configuration, as described above.

Process 700 may include additional aspects, such as any single aspect or any combination of aspects described below and/or in connection with one or more other processes described elsewhere herein.

In some aspects, the at least one adjacent symbol comprises at least one indication that indicates a first set of symbols occurring immediately before the at least one measurement symbol and a second set of symbols occurring immediately after the at least one measurement symbol. In some aspects, the measurement configuration comprises at least one of a first indication of a first quantity of symbols in the first set of symbols or a second indication of a second quantity of symbols in the second set of symbols. In some aspects, the first quantity of symbols is equal to the second quantity of symbols. In some aspects, the first quantity of symbols comprises a configured value. In some aspects, the first quantity of symbols is based at least in part on at least one of a downlink bandwidth part subcarrier spacing associated with the reference signal or a frequency range associated with the reference signal.

In some aspects, the at least one adjacent symbol comprises at least one data symbol. In some aspects, the scheduling restriction corresponds to at least a portion of a measurement window duration. In some aspects alone or in combination with one or more of the first through seventh aspects, the at least the portion of the measurement window duration comprises a portion of the measurement window duration that is less than an entire measurement window duration. In some aspects, the first cell is synchronized with the second cell, and wherein an SSB index associated with the second cell corresponds to an SSB index associated with the first cell. In a tenth aspect, alone or in combination with one or more of the first through ninth aspects, the at least the portion of the measurement window duration comprises an entire measurement window duration. In some aspects, the first cell is asynchronized with the second cell, and wherein an index associated with the second cell does not correspond to an SSB index associated with the first cell.

In some aspects, the measurement window duration corresponds to at least one of a SMTC window or a measurement gap window. In some aspects, the reference signal comprises a synchronization signal block associated with a neighbor cell, and wherein the measurement window duration corresponds to the SMTC window.

In some aspects, the first cell comprises a serving cell and the second cell comprises a neighbor cell, and wherein the reference signal comprises at least one of an SSB configured for the neighbor cell, a CSI-RS configured for the neighbor cell, or a CSI-RS configured for the serving cell, wherein the SSB of the neighbor cell provides a quasi co-location source reference signal for the CSI-RS configured for the serving cell.

In some aspects, the L1 measurement comprises at least one of an intra-frequency L1 measurement or an inter-frequency L1 measurement.

In some aspects, the L1 measurement corresponds to at least one of a time division duplexing band or a frequency division duplexing band. In some aspects, the L1 measurement corresponds to at least one of a first frequency range, a second frequency range, a third frequency range, or a fourth frequency range.

In some aspects, the reference signal is associated with a first subcarrier spacing, wherein the reference signal overlaps an additional reference signal associated with a second subcarrier spacing that is different than the first subcarrier spacing, and wherein a user equipment does not support simultaneous reception of the reference signal and the additional reference signal. In some aspects, the reference signal is associated with a first reception beam, wherein the reference signal overlaps an additional reference signal associated with a second reception beam that is different than the first reception beam, and wherein a user equipment does not support simultaneous reception of the reference signal and the additional reference signal. In some aspects, the scheduling restriction is not applied with a measurement gap.

In some aspects, the scheduling restriction is applied with a measurement gap. In some aspects, the scheduling restriction is applied with the measurement gap based at least in part on the reference signal being outside of an active downlink bandwidth part.

In some aspects, the scheduling restriction is applied with the measurement gap based at least in part on an active downlink BWP associated with the reference signal being different from an initial BWP. In some aspects, the reference signal corresponds to a first subcarrier spacing, and wherein the scheduling restriction is applied with the measurement gap based at least in part on the first subcarrier spacing being different from a second subcarrier spacing corresponding to an active bandwidth part.

In some aspects, process 700 includes transmitting a configuration associated with a plurality of candidate cells for the L1/L2 inter-cell mobility operation, wherein the measurement configuration indicates a set of measurement gap configurations for L1 measurements associated with the plurality of candidate cells. In some aspects, process 700 includes transmitting an indication of a selected measurement gap configuration parameter associated with the set of measurement gap configurations. In some aspects, transmitting the indication of the selected measurement gap configuration comprises transmitting at least one of a MAC CE or a DCI transmission.

In some aspects, the MAC CE indicates a subset of measurement gap configurations, of the set of measurement gap configurations, associated with a candidate cell of the plurality of candidate cells. In some aspects, the DCI transmission indicates a measurement gap configuration of the subset of measurement gap configurations. In some aspects, the MAC CE indicates only one measurement gap configuration, of the set of measurement gap configurations, as an active measurement gap configuration associated with a candidate cell of the plurality of candidate cells. In some aspects, a selected measurement gap configuration, of the set of measurement gap configurations, is based at least in part on a measurement gap parameter, corresponding to the selected measurement gap configuration, satisfying an implicit condition, wherein the measurement gap parameter comprises a measurement gap configuration ID, and wherein the measurement gap parameter satisfies the implicit condition based at least in part on the measurement gap configuration ID having a minimum value of a plurality of values corresponding to a plurality of measurement gap configuration IDs associated with the set of measurement gap configurations.

In some aspects, a first L1 measurement is associated with the reference signal, wherein the reference signal comprises a first SSB, and wherein a second L1 measurement is associated with a second SSB that overlaps the first SSB based at least in part on the second SSB satisfying an overlap measurement condition. In some aspects, alone or in combination with one or more of the first through thirty-second aspects, the overlap measurement condition corresponds to a capability of a user equipment. In some aspects, the first SSB corresponds to a first SCS and the second SSB corresponds to a second SCS, and wherein the second SSB satisfies the overlap measurement condition based at least in part on the second SCS being different from the first SCS. In some aspects, the second SSB satisfies the overlap measurement condition based at least in part on a QCL associated with the first SSB and the second SSB being unknown.

In some aspects, the reference signal comprises a first SSB, the method further comprising transmitting a second SSB that overlaps the first SSB, wherein an L1 measurement associated with a measured SSB of the first SSB and the second SSB is based at least in part on a first priority of the measured SSB being greater than a second priority of an unmeasured SSB of the first SSB and the second SSB. The first priority is greater than the second priority based at least in part on the first priority corresponding to a serving cell. In some aspects the first priority is greater than the second priority based at least in part on the first priority corresponding to a non-serving cell.

In some aspects, the first priority corresponds to a first cell having a first PCI and the second priority corresponds to a second cell having a second PCI, wherein the first priority is greater than the second priority based at least in part on the first PCI being greater than the second PCI. In some aspects, the first priority corresponds to a first cell having a first PCI and the second priority corresponds to a second cell having a second PCI, wherein the first priority is greater than the second priority based at least in part on the first PCI being less than the second PCI.

In some aspects, the first priority corresponds to a first communication failure function and the second priority corresponds to a second communication failure function, wherein the first priority is greater than the second priority based at least in part on the first priority corresponding to the first communication failure function. In some aspects, the reference signal corresponds to a first component carrier, the method further comprising communicating a signal corresponding to a second component carrier that is different from the first component carrier. In some aspects, the first component carrier and the second component carrier are both associated with a band or a band combination. In some aspects, the first cell and the second cell are synchronized.

In some aspects, the first cell and the second cell are synchronized based at least in part on an alignment, between the first cell and the second cell, of at least one cell feature, the at least one cell feature comprising at least one of a downlink frame transmission boundary, a downlink slot transmission boundary, or a downlink symbol transmission boundary. In some aspects, the first cell and the second cell are synchronized based at least in part on a timing difference between the first cell and the second cell satisfying a timing difference threshold.

In some aspects, a plurality of L1 measurements are based at least in part on a UE capability associated with at least one of a maximum quantity of identified cells, a maximum quantity of SSB indices corresponding to an intra-frequency layer, a maximum quantity of SSB indices corresponding to an inter-frequency layer, a maximum quantity of PCIs corresponding to an intra-frequency layer, a maximum quantity of PCIs corresponding to an inter-frequency layer, or a maximum quantity of SSBs per identified cell of the identified cells.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a communication manager 808. The communication manager 808 may include a determination component 810.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal. The reception component 802 may receive the reference signal based at least in part on the measurement configuration.

The reception component 802 may obtain an L1 measurement metric corresponding to the L1 measurement, the L1 measurement metric comprising at least one of a reference signal received power, a signal-to-interference-plus-noise ratio, or a reference signal received quality. The reception component 802 may obtain a measurement corresponding to the reference signal based at least in part on receiving the reference signal during a configured time period, wherein the configured time period comprises an overlap, in a time domain, of the measurement gap and a switching period.

The reception component 802 may receive a configuration associated with a plurality of candidate cells for the L1/L2 inter-cell mobility operation, wherein the measurement configuration indicates a set of measurement gap configurations for L1 measurements associated with the plurality of candidate cells. The reception component 802 may receive an indication of a selected measurement gap configuration associated with the set of measurement gap configurations.

The communication manager 808 and/or the determination component 810 may determine a selected measurement gap configuration, of the set of measurement gap configurations, based at least in part on a measurement gap parameter, corresponding to the selected measurement gap configuration, satisfying an implicit condition. In some aspects, the communication manager 808 may include one or more antennas, a modem, a controller/processor, a memory, or a combination thereof, of the UE described in connection with FIG. 2. In some aspects, the communication manager 808 may include the reception component 802 and/or the transmission component 804. In some aspects, the communication manager 808 may be, be similar to, include, or be included in, the communication manager 140 depicted in FIGS. 1 and 2. In some aspects, the determination component 810 may include one or more antennas, a modem, a controller/processor, a memory, or a combination thereof, of the UE described in connection with FIG. 2. In some aspects, the determination component 810 may include the reception component 802 and/or the transmission component 804.

The reception component 802 may obtain a first L1 measurement associated with the reference signal, wherein the reference signal comprises a first SSB. The reception component 802 may obtain a second L1 measurement associated with a second SSB that overlaps the first SSB based at least in part on the second SSB satisfying an overlap measurement condition. The reception component 802 may obtain a plurality of L1 measurements based at least in part on a UE capability associated with at least one of a maximum quantity of identified cells, a maximum quantity of SSB indices corresponding to an intra-frequency layer, a maximum quantity of SSB indices corresponding to an inter-frequency layer, a maximum quantity of PCIs corresponding to an intra-frequency layer, a maximum quantity of PCIs corresponding to an inter-frequency layer, or a maximum quantity of SSBs per identified cell of the identified cells.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a communication manager 908.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE and/or the base station described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE and/or the base station described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE and/or the base station described in connection with FIG. 2. In some aspects, the transmission component 904 may be co-located with the reception component 902 in a transceiver.

The communication manager 908 and/or the transmission component 904 may transmit a measurement configuration indicating a scheduling restriction corresponding to an L1 measurement of a reference signal associated with an L1/L2 inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal. In some aspects, the communication manager 908 may include one or more antennas, a modem, a controller/processor, a memory, or a combination thereof, of the UE and/or the base station described in connection with FIG. 2. In some aspects, the communication manager 908 may include the reception component 902 and/or the transmission component 904. In some aspects, the communication manager 908 may be, be similar to, include, or be included in, the communication manager 140 depicted in FIGS. 1 and 2.

The transmission component 904 may transmit the reference signal based at least in part on the measurement configuration. The transmission component 904 may transmit a configuration associated with a plurality of candidate cells for the L1/L2 inter-cell mobility operation, wherein the measurement configuration indicates a set of measurement gap configurations for L1 measurements associated with the plurality of candidate cells. The transmission component 904 may transmit an indication of a selected measurement gap configuration associated with the set of measurement gap configurations.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: receiving a measurement configuration indicating a scheduling restriction corresponding to a Layer 1 (L1) measurement of a reference signal associated with an L1 or Layer 2 (L1/L2) inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal; and receiving the reference signal based at least in part on the measurement configuration.
Aspect 2: The method of Aspect 1, wherein the at least one adjacent symbol comprises at least one indication that indicates a first set of symbols occurring immediately before the at least one measurement symbol and a second set of symbols occurring immediately after the at least one measurement symbol.
Aspect 3: The method of Aspect 2, wherein the measurement configuration comprises at least one of a first indication of a first quantity of symbols in the first set of symbols or a second indication of a second quantity of symbols in the second set of symbols.
Aspect 4: The method of Aspect 3, wherein the first quantity of symbols is equal to the second quantity of symbols.
Aspect 5: The method of Aspect 4, wherein the first quantity of symbols comprises a configured value.
Aspect 6: The method of either of Aspects 4 or 5, wherein the first quantity of symbols is based at least in part on at least one of a downlink bandwidth part subcarrier spacing associated with the reference signal or a frequency range associated with the reference signal.
Aspect 7: The method of any of Aspects 1-6, wherein the at least one adjacent symbol comprises at least one data symbol.
Aspect 8: The method of any of Aspects 1-7, wherein the scheduling restriction corresponds to at least a portion of a measurement window duration.
Aspect 9: The method of Aspect 8, wherein the at least the portion of the measurement window duration comprises a portion of the measurement window duration that is less than an entire measurement window duration.
Aspect 10: The method of Aspect 9, wherein the first cell is synchronized with the second cell, and wherein a synchronization signal block (SSB) index associated with the second cell corresponds to an SSB index associated with the first cell.
Aspect 11: The method of any of Aspects 8-10, wherein the at least the portion of the measurement window duration comprises an entire measurement window duration.
Aspect 12: The method of Aspect 11, wherein the first cell is asynchronized with the second cell, and wherein a synchronization signal block (SSB) index associated with the second cell does not correspond to an SSB index associated with the first cell.
Aspect 13: The method of any of Aspects 8-12, wherein the measurement window duration corresponds to at least one of a synchronization signal/physical broadcast channel block measurement timing configuration (SMTC) window or a measurement gap window.
Aspect 14: The method of Aspect 13, wherein the reference signal comprises a synchronization signal block associated with a neighbor cell, and wherein the measurement window duration corresponds to the SMTC window.
Aspect 15: The method of any of Aspects 1-14, wherein the first cell comprises a serving cell and the second cell comprises a neighbor cell, and wherein the reference signal comprises at least one of: a synchronization signal block (SSB) configured for the neighbor cell, a channel state information-reference signal (CSI-RS) configured for the neighbor cell, or a CSI-RS configured for the serving cell, wherein the SSB of the neighbor cell provides a quasi co-location source reference signal for the CSI-RS configured for the serving cell.
Aspect 16: The method of any of Aspects 1-15, wherein the L1 measurement comprises at least one of an intra-frequency L1 measurement or an inter-frequency L1 measurement.
Aspect 17: The method of any of Aspects 1-16, wherein the L1 measurement corresponds to at least one of a time division duplexing band or a frequency division duplexing band.
Aspect 18: The method of any of Aspects 1-17, wherein the L1 measurement corresponds to at least one of a first frequency range, a second frequency range, a third frequency range, or a fourth frequency range.
Aspect 19: The method of any of Aspects 1-18, wherein the reference signal is associated with a first subcarrier spacing, wherein the reference signal overlaps an additional reference signal associated with a second subcarrier spacing that is different than the first subcarrier spacing, and wherein the UE does not support simultaneous reception of the reference signal and the additional reference signal.
Aspect 20: The method of any of Aspects 1-19, wherein the reference signal is associated with a first reception beam, wherein the reference signal overlaps an additional reference signal associated with a second reception beam that is different than the first reception beam, and wherein the UE does not support simultaneous reception of the reference signal and the additional reference signal.
Aspect 21: The method of any of Aspects 1-20, further comprising obtaining an L1 measurement metric corresponding to the L1 measurement, the L1 measurement metric comprising at least one of a reference signal received power, a signal-to-interference-plus-noise ratio, or a reference signal received quality.
Aspect 22: The method of any of Aspects 1-21, wherein the scheduling restriction is not applied with a measurement gap.
Aspect 23: The method of any of Aspects 1-21, wherein the scheduling restriction is applied with a measurement gap.
Aspect 24: The method of Aspect 23, wherein the scheduling restriction is applied with the measurement gap based at least in part on the reference signal being outside of an active downlink bandwidth part.
Aspect 25: The method of either of Aspects 23 or 24, wherein the scheduling restriction is applied with the measurement gap based at least in part on an active downlink bandwidth part (BWP) associated with the reference signal being different from an initial BWP.
Aspect 26: The method of any of Aspects 23-25, wherein the reference signal corresponds to a first subcarrier spacing, and wherein the scheduling restriction is applied with the measurement gap based at least in part on the first subcarrier spacing being different from a second subcarrier spacing corresponding to an active bandwidth part.
Aspect 27: The method of any of Aspects 23-26, further comprising obtaining a measurement corresponding to the reference signal based at least in part on receiving the reference signal during a configured time period, wherein the configured time period comprises an overlap, in a time domain, of the measurement gap and a switching period.
Aspect 28: The method of any of Aspects 1-27, further comprising receiving a configuration associated with a plurality of candidate cells for the L1/L2 inter-cell mobility operation, wherein the measurement configuration indicates a set of measurement gap configurations for L1 measurements associated with the plurality of candidate cells.
Aspect 29: The method of Aspect 28, further comprising receiving an indication of a selected measurement gap configuration associated with the set of measurement gap configurations.
Aspect 30: The method of Aspect 29, wherein receiving the indication of the selected measurement gap configuration comprises receiving at least one of a medium access control (MAC) control element (MAC CE) or a downlink control information (DCI) transmission.
Aspect 31: The method of Aspect 30, wherein the MAC CE indicates a subset of measurement gap configurations, of the set of measurement gap configurations, associated with a candidate cell of the plurality of candidate cells.
Aspect 32: The method of Aspect 31, wherein the DCI transmission indicates a measurement gap configuration of the subset of measurement gap configurations.
Aspect 33: The method of any of Aspects 30-32, wherein the MAC CE indicates only one measurement gap configuration, of the set of measurement gap configurations, as an active measurement gap configuration associated with a candidate cell of the plurality of candidate cells.
Aspect 34: The method of any of Aspects 28-33, further comprising determining a selected measurement gap configuration, of the set of measurement gap configurations, based at least in part on a measurement gap parameter, corresponding to the selected measurement gap configuration, satisfying an implicit condition.
Aspect 35: The method of Aspect 34, wherein the measurement gap parameter comprises a measurement gap configuration identifier (ID), and wherein the measurement gap parameter satisfies the implicit condition based at least in part on the measurement gap configuration ID having a minimum value of a plurality of values corresponding to a plurality of measurement gap configuration IDs associated with the set of measurement gap configurations.
Aspect 36: The method of any of Aspects 1-35, further comprising: obtaining a first L1 measurement associated with the reference signal, wherein the reference signal comprises a first synchronization signal block (SSB); and obtaining a second L1 measurement associated with a second SSB that overlaps the first SSB based at least in part on the second SSB satisfying an overlap measurement condition.
Aspect 37: The method of Aspect 36, wherein the overlap measurement condition corresponds to a capability of the UE.
Aspect 38: The method of either of Aspects 36 or 37, wherein the first SSB corresponds to a first subcarrier spacing (SCS) and the second SSB corresponds to a second SCS, and wherein the second SSB satisfies the overlap measurement condition based at least in part on the second SCS being different from the first SCS.
Aspect 39: The method of any of Aspects 36-38, wherein the second SSB satisfies the overlap measurement condition based at least in part on a quasi co-location associated with the first SSB and the second SSB being unknown.
Aspect 40: The method of any of Aspects 1-39, wherein the reference signal comprises a first synchronization signal block (SSB), the method further comprising: receiving a second SSB that overlaps the first SSB; and obtaining an L1 measurement associated with a measured SSB of the first SSB and the second SSB based at least in part on a first priority of the measured SSB being greater than a second priority of an unmeasured SSB of the first SSB and the second SSB.
Aspect 41: The method of Aspect 40, wherein the first priority is greater than the second priority based at least in part on the first priority corresponding to a serving cell.
Aspect 42: The method of either of Aspects 40 or 41, wherein the first priority is greater than the second priority based at least in part on the first priority corresponding to a non-serving cell.
Aspect 43: The method of any of Aspects 40-42, wherein the first priority corresponds to a first cell having a first physical cell identifier (PCI) and the second priority corresponds to a second cell having a second PCI, wherein the first priority is greater than the second priority based at least in part on the first PCI being greater than the second PCI.
Aspect 44: The method of any of Aspects 40-43, wherein the first priority corresponds to a first cell having a first physical cell identifier (PCI) and the second priority corresponds to a second cell having a second PCI, wherein the first priority is greater than the second priority based at least in part on the first PCI being less than the second PCI.
Aspect 45: The method of any of Aspects 40-44, wherein the first priority corresponds to a first communication failure function and the second priority corresponds to a second communication failure function, wherein the first priority is greater than the second priority based at least in part on the first priority corresponding to the first communication failure function.
Aspect 46: The method of any of Aspects 40-45, wherein the reference signal corresponds to a first component carrier, the method further comprising communicating a signal corresponding to a second component carrier that is different from the first component carrier.
Aspect 47: The method of Aspect 46, wherein the first component carrier and the second component carrier are both associated with a band or a band combination.
Aspect 48: The method of any of Aspects 1-47, wherein the first cell and the second cell are synchronized.
Aspect 49: The method of Aspect 48, wherein the first cell and the second cell are synchronized based at least in part on an alignment, between the first cell and the second cell, of at least one cell feature, the at least one cell feature comprising at least one of: a downlink frame transmission boundary, a downlink slot transmission boundary, or a downlink symbol transmission boundary.
Aspect 50: The method of either of Aspects 48 or 49, wherein the first cell and the second cell are synchronized based at least in part on a timing difference between the first cell and the second cell satisfying a timing difference threshold.
Aspect 51: The method of any of Aspects 1-50, further comprising obtaining a plurality of L1 measurements based at least in part on a UE capability associated with at least one of: a maximum quantity of identified cells, a maximum quantity of synchronization signal block (SSB) indices corresponding to an intra-frequency layer, a maximum quantity of SSB indices corresponding to an inter-frequency layer, a maximum quantity of PCIs corresponding to an intra-frequency layer, a maximum quantity of PCIs corresponding to an inter-frequency layer, or a maximum quantity of SSBs per identified cell of the identified cells.
Aspect 52: A method of wireless communication performed by a network node, comprising: transmitting a measurement configuration indicating a scheduling restriction corresponding to a Layer 1 (L1) measurement of a reference signal associated with an L1 or Layer 2 (L1/L2) inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal;
and transmitting the reference signal based at least in part on the measurement configuration.
Aspect 53: The method of Aspect 52, wherein the at least one adjacent symbol comprises at least one indication that indicates a first set of symbols occurring immediately before the at least one measurement symbol and a second set of symbols occurring immediately after the at least one measurement symbol.
Aspect 54: The method of Aspect 53, wherein the measurement configuration comprises at least one of a first indication of a first quantity of symbols in the first set of symbols or a second indication of a second quantity of symbols in the second set of symbols.
Aspect 55: The method of Aspect 54, wherein the first quantity of symbols is equal to the second quantity of symbols.
Aspect 56: The method of Aspect 55, wherein the first quantity of symbols comprises a configured value.
Aspect 57: The method of either of Aspects 55 or 56, wherein the first quantity of symbols is based at least in part on at least one of a downlink bandwidth part subcarrier spacing associated with the reference signal or a frequency range associated with the reference signal.
Aspect 58: The method of any of Aspects 52-57, wherein the at least one adjacent symbol comprises at least one data symbol.
Aspect 59: The method of any of Aspects 52-58, wherein the scheduling restriction corresponds to at least a portion of a measurement window duration.
Aspect 60: The method of Aspect 59, wherein the at least the portion of the measurement window duration comprises a portion of the measurement window duration that is less than an entire measurement window duration.
Aspect 61: The method of Aspect 60, wherein the first cell is synchronized with the second cell, and wherein a synchronization signal block (SSB) index associated with the second cell corresponds to an SSB index associated with the first cell.
Aspect 62: The method of any of Aspects 59-61, wherein the at least the portion of the measurement window duration comprises an entire measurement window duration.
Aspect 63: The method of Aspect 62, wherein the first cell is asynchronized with the second cell, and wherein a synchronization signal block (SSB) index associated with the second cell does not correspond to an SSB index associated with the first cell.
Aspect 64: The method of any of Aspects 59-63, wherein the measurement window duration corresponds to at least one of a synchronization signal/physical broadcast channel block measurement timing configuration (SMTC) window or a measurement gap window.
Aspect 65: The method of Aspect 64, wherein the reference signal comprises a synchronization signal block associated with a neighbor cell, and wherein the measurement window duration corresponds to the SMTC window.
Aspect 66: The method of any of Aspects 52-65, wherein the first cell comprises a serving cell and the second cell comprises a neighbor cell, and wherein the reference signal comprises at least one of: a synchronization signal block (SSB) configured for the neighbor cell, a channel state information-reference signal (CSI-RS) configured for the neighbor cell, or a CSI-RS configured for the serving cell, wherein the SSB of the neighbor cell provides a quasi co-location source reference signal for the CSI-RS configured for the serving cell.
Aspect 67: The method of any of Aspects 52-66, wherein the L1 measurement comprises at least one of an intra-frequency L1 measurement or an inter-frequency L1 measurement.
Aspect 68: The method of any of Aspects 52-67, wherein the L1 measurement corresponds to at least one of a time division duplexing band or a frequency division duplexing band.
Aspect 69: The method of any of Aspects 52-68, wherein the L1 measurement corresponds to at least one of a first frequency range, a second frequency range, a third frequency range, or a fourth frequency range.
Aspect 70: The method of any of Aspects 52-69, wherein the reference signal is associated with a first subcarrier spacing, wherein the reference signal overlaps an additional reference signal associated with a second subcarrier spacing that is different than the first subcarrier spacing, and wherein a user interface does not support simultaneous reception of the reference signal and the additional reference signal.
Aspect 71: The method of any of Aspects 52-70, wherein the reference signal is associated with a first reception beam, wherein the reference signal overlaps an additional reference signal associated with a second reception beam that is different than the first reception beam, and wherein a user interface does not support simultaneous reception of the reference signal and the additional reference signal.
Aspect 72: The method of any of Aspects 52-71, wherein the scheduling restriction is not applied with a measurement gap.
Aspect 73: The method of any of Aspects 52-71, wherein the scheduling restriction is applied with a measurement gap.
Aspect 74: The method of Aspect 73, wherein the scheduling restriction is applied with the measurement gap based at least in part on the reference signal being outside of an active downlink bandwidth part.
Aspect 75: The method of either of Aspects 73 or 74, wherein the scheduling restriction is applied with the measurement gap based at least in part on an active downlink bandwidth part (BWP) associated with the reference signal being different from an initial BWP.
Aspect 76: The method of any of Aspects 73-75, wherein the reference signal corresponds to a first subcarrier spacing, and wherein the scheduling restriction is applied with the measurement gap based at least in part on the first subcarrier spacing being different from a second subcarrier spacing corresponding to an active bandwidth part.
Aspect 77: The method of any of Aspects 52-76, further comprising transmitting a configuration associated with a plurality of candidate cells for the L1/L2 inter-cell mobility operation, wherein the measurement configuration indicates a set of measurement gap configurations for L1 measurements associated with the plurality of candidate cells.
Aspect 78: The method of Aspect 77, further comprising transmitting an indication of a selected measurement gap configuration associated with the set of measurement gap configurations.
Aspect 79: The method of Aspect 78, wherein transmitting the indication of the selected measurement gap configuration comprises transmitting at least one of a medium access control (MAC) control element (MAC CE) or a downlink control information (DCI) transmission.
Aspect 80: The method of Aspect 79, wherein the MAC CE indicates a subset of measurement gap configurations, of the set of measurement gap configurations, associated with a candidate cell of the plurality of candidate cells.
Aspect 81: The method of Aspect 80, wherein the DCI transmission indicates a measurement gap configuration of the subset of measurement gap configurations.
Aspect 82: The method of any of Aspects 79-81, wherein the MAC CE indicates only one measurement gap configuration, of the set of measurement gap configurations, as an active measurement gap configuration associated with a candidate cell of the plurality of candidate cells.
Aspect 83: The method of any of Aspects 77-82, wherein a selected measurement gap configuration, of the set of measurement gap configurations, is based at least in part on a measurement gap parameter, corresponding to the selected measurement gap configuration, satisfying an implicit condition, wherein the measurement gap parameter comprises a measurement gap configuration identifier (ID), and wherein the measurement gap parameter satisfies the implicit condition based at least in part on the measurement gap configuration ID having a minimum value of a plurality of values corresponding to a plurality of measurement gap configuration IDs associated with the set of measurement gap configurations.
Aspect 84: The method of any of Aspects 52-83, wherein a first L1 measurement is associated with the reference signal, wherein the reference signal comprises a first synchronization signal block (SSB); and wherein a second L1 measurement is associated with a second SSB that overlaps the first SSB based at least in part on the second SSB satisfying an overlap measurement condition.
Aspect 85: The method of Aspect 84, wherein the overlap measurement condition corresponds to a capability of a user interface.
Aspect 86: The method of either of Aspects 84 or 85, wherein the first SSB corresponds to a first subcarrier spacing (SCS) and the second SSB corresponds to a second SCS, and wherein the second SSB satisfies the overlap measurement condition based at least in part on the second SCS being different from the first SCS.
Aspect 87: The method of any of Aspects 84-86, wherein the second SSB satisfies the overlap measurement condition based at least in part on a quasi co-location associated with the first SSB and the second SSB being unknown.
Aspect 88: The method of any of Aspects 52-87, wherein the reference signal comprises a first synchronization signal block (SSB), the method further comprising transmitting a second SSB that overlaps the first SSB, wherein an L1 measurement associated with a measured SSB of the first SSB and the second SSB is based at least in part on a first priority of the measured SSB being greater than a second priority of an unmeasured SSB of the first SSB and the second SSB.
Aspect 89: The method of Aspect 88, wherein the first priority is greater than the second priority based at least in part on the first priority corresponding to a serving cell.
Aspect 90: The method of either of Aspects 88 or 89, wherein the first priority is greater than the second priority based at least in part on the first priority corresponding to a non-serving cell.
Aspect 91: The method of any of Aspects 88-90, wherein the first priority corresponds to a first cell having a first physical cell identifier (PCI) and the second priority corresponds to a second cell having a second PCI, wherein the first priority is greater than the second priority based at least in part on the first PCI being greater than the second PCI.
Aspect 92: The method of any of Aspects 88-91, wherein the first priority corresponds to a first cell having a first physical cell identifier (PCI) and the second priority corresponds to a second cell having a second PCI, wherein the first priority is greater than the second priority based at least in part on the first PCI being less than the second PCI.
Aspect 93: The method of any of Aspects 88-92, wherein the first priority corresponds to a first communication failure function and the second priority corresponds to a second communication failure function, wherein the first priority is greater than the second priority based at least in part on the first priority corresponding to the first communication failure function.
Aspect 94: The method of any of Aspects 52-93, wherein the reference signal corresponds to a first component carrier, the method further comprising communicating a signal corresponding to a second component carrier that is different from the first component carrier.
Aspect 95: The method of Aspect 94, wherein the first component carrier and the second component carrier are both associated with a band or a band combination.
Aspect 96: The method of any of Aspects 52-95, wherein the first cell and the second cell are synchronized.
Aspect 97: The method of Aspect 96, wherein the first cell and the second cell are synchronized based at least in part on an alignment, between the first cell and the second cell, of at least one cell feature, the at least one cell feature comprising at least one of: a downlink frame transmission boundary, a downlink slot transmission boundary, or a downlink symbol transmission boundary.
Aspect 98: The method of either of Aspects 96 or 97, wherein the first cell and the second cell are synchronized based at least in part on a timing difference between the first cell and the second cell satisfying a timing difference threshold.
Aspect 99: The method of any of Aspects 52-98, wherein a plurality of L1 measurements are based at least in part on a UE capability associated with at least one of: a maximum quantity of identified cells, a maximum quantity of synchronization signal block (SSB) indices corresponding to an intra-frequency layer, a maximum quantity of SSB indices corresponding to an inter-frequency layer, a maximum quantity of physical cell identifiers (PCIs) corresponding to an intra-frequency layer, a maximum quantity of PCIs corresponding to an inter-frequency layer, or a maximum quantity of SSBs per identified cell of the identified cells.
Aspect 100: An apparatus for wireless communication at a device, comprising a processor; memory coupled with the processor; and instructions stored in the memory and executable by the processor to cause the apparatus to perform the method of one or more of Aspects 1-51.
Aspect 101: A device for wireless communication, comprising a memory and one or more processors coupled to the memory, the one or more processors configured to perform the method of one or more of Aspects 1-51.
Aspect 102: An apparatus for wireless communication, comprising at least one means for performing the method of one or more of Aspects 1-51.
Aspect 103: A non-transitory computer-readable medium storing code for wireless communication, the code comprising instructions executable by a processor to perform the method of one or more of Aspects 1-51.
Aspect 104: A non-transitory computer-readable medium storing a set of instructions for wireless communication, the set of instructions comprising one or more instructions that, when executed by one or more processors of a device, cause the device to perform the method of one or more of Aspects 1-51.
Aspect 105: An apparatus for wireless communication at a device, comprising a processor; memory coupled with the processor; and instructions stored in the memory and executable by the processor to cause the apparatus to perform the method of one or more of Aspects 52-99.
Aspect 106: A device for wireless communication, comprising a memory and one or more processors coupled to the memory, the one or more processors configured to perform the method of one or more of Aspects 52-99.
Aspect 107: An apparatus for wireless communication, comprising at least one means for performing the method of one or more of Aspects 52-99.
Aspect 108: A non-transitory computer-readable medium storing code for wireless communication, the code comprising instructions executable by a processor to perform the method of one or more of Aspects 52-99.
Aspect 109: A non-transitory computer-readable medium storing a set of instructions for wireless communication, the set of instructions comprising one or more instructions that, when executed by one or more processors of a device, cause the device to perform the method of one or more of Aspects 52-99.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors, coupled to the one or more memories, configured to:
receive a measurement configuration indicating a scheduling restriction corresponding to a Layer 1 (L1) measurement of a reference signal associated with an L1 or Layer 2 (L1/L2) inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal; and
receive the reference signal based at least in part on the measurement configuration.

2. The UE of claim 1, wherein the at least one adjacent symbol comprises at least one indication that indicates a first set of symbols occurring immediately before the at least one measurement symbol and a second set of symbols occurring immediately after the at least one measurement symbol.

3-7. (canceled)

8. The UE of claim 1, wherein the scheduling restriction corresponds to at least a portion of a measurement window duration.

9-10. (canceled)

11. The UE of claim 8, wherein the at least the portion of the measurement window duration comprises an entire measurement window duration.

12. The UE of claim 11, wherein the first cell is asynchronized with the second cell, and wherein a synchronization signal block (SSB) index associated with the second cell does not correspond to an SSB index associated with the first cell.

13. The UE of claim 8, wherein the measurement window duration corresponds to at least one of a synchronization signal/physical broadcast channel block measurement timing configuration (SMTC) window or a measurement gap window.

14. The UE of claim 13, wherein the reference signal comprises a synchronization signal block associated with a neighbor cell, and wherein the measurement window duration corresponds to the SMTC window.

15-22. (canceled)

23. The UE of claim 1, wherein the scheduling restriction is applied with a measurement gap.

24. The UE of claim 23, wherein the scheduling restriction is applied with the measurement gap based at least in part on the reference signal being outside of an active downlink bandwidth part.

25. The UE of claim 23, wherein the scheduling restriction is applied with the measurement gap based at least in part on an active downlink bandwidth part (BWP) associated with the reference signal being different from an initial BWP.

26. The UE of claim 23, wherein the reference signal corresponds to a first subcarrier spacing, and wherein the scheduling restriction is applied with the measurement gap based at least in part on the first subcarrier spacing being different from a second subcarrier spacing corresponding to an active bandwidth part.

27. The UE of claim 23, wherein the one or more processors are further configured to obtain a measurement corresponding to the reference signal based at least in part on receiving the reference signal during a configured time period, wherein the configured time period comprises an overlap, in a time domain, of the measurement gap and a switching period.

28. The UE of claim 1, wherein the one or more processors are further configured to receive a configuration associated with a plurality of candidate cells for the L1/L2 inter-cell mobility operation, wherein the measurement configuration indicates a set of measurement gap configurations for L1 measurements associated with the plurality of candidate cells.

29. The UE of claim 28, wherein the one or more processors are further configured to receive an indication of a selected measurement gap configuration associated with the set of measurement gap configurations.

30. The UE of claim 29, wherein the one or more processors, to receive the indication of the selected measurement gap configuration, are configured to receive at least one of a medium access control (MAC) control element (MAC CE) or a downlink control information (DCI) transmission.

31. The UE of claim 30, wherein the MAC CE indicates a subset of measurement gap configurations, of the set of measurement gap configurations, associated with a candidate cell of the plurality of candidate cells.

32. The UE of claim 31, wherein the DCI transmission indicates a measurement gap configuration of the subset of measurement gap configurations.

33. The UE of claim 30, wherein the MAC CE indicates only one measurement gap configuration, of the set of measurement gap configurations, as an active measurement gap configuration associated with a candidate cell of the plurality of candidate cells.

34. The UE of claim 28, wherein the one or more processors are further configured to determine a selected measurement gap configuration, of the set of measurement gap configurations, based at least in part on a measurement gap parameter, corresponding to the selected measurement gap configuration, satisfying an implicit condition.

35. The UE of claim 34, wherein the measurement gap parameter comprises a measurement gap configuration identifier (ID), and wherein the measurement gap parameter satisfies the implicit condition based at least in part on the measurement gap configuration ID having a minimum value of a plurality of values corresponding to a plurality of measurement gap configuration IDs associated with the set of measurement gap configurations.

36. The UE of claim 1, wherein the one or more processors are further configured to:
obtain a first L1 measurement associated with the reference signal, wherein the reference signal comprises a first synchronization signal block (SSB); and
obtain a second L1 measurement associated with a second SSB that overlaps the first SSB based at least in part on the second SSB satisfying an overlap measurement condition.

37-45. (canceled)

46. The UE of claim 1, wherein the reference signal corresponds to a first component carrier, and wherein the one or more processors are further configured to communicate a signal corresponding to a second component carrier that is different from the first component carrier.

47. The UE of claim 46, wherein the first component carrier and the second component carrier are both associated with a band or a band combination.

48. The UE of claim 1, wherein the first cell and the second cell are synchronized.

49. The UE of claim 48, wherein the first cell and the second cell are synchronized based at least in part on an alignment, between the first cell and the second cell, of at least one cell feature, the at least one cell feature comprising at least one of:
a downlink frame transmission boundary,
a downlink slot transmission boundary, or
a downlink symbol transmission boundary.

50. The UE of claim 48, wherein the first cell and the second cell are synchronized based at least in part on a timing difference between the first cell and the second cell satisfying a timing difference threshold.

51. The UE of claim 1, wherein the one or more processors are further configured to obtain a plurality of L1 measurements based at least in part on a UE capability associated with at least one of:
a maximum quantity of identified cells,
a maximum quantity of synchronization signal block (SSB) indices corresponding to an intra-frequency layer,
a maximum quantity of SSB indices corresponding to an inter-frequency layer, a maximum quantity of physical cell identifiers (PCIs) corresponding to an intra-frequency layer,
a maximum quantity of PCIs corresponding to an inter-frequency layer, or a maximum quantity of SSBs per identified cell of the identified cells.

52. A network node for wireless communication, comprising:
one or more memories; and
one or more processors, coupled to the one or more memories, configured to:
transmit a measurement configuration indicating a scheduling restriction corresponding to a Layer 1 (L1) measurement of a reference signal associated with an L1 or Layer 2 (L1/L2) inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal; and
transmit the reference signal based at least in part on the measurement configuration.

53-99. (canceled)

100. A method of wireless communication performed by a user equipment (UE), comprising:
receiving a measurement configuration indicating a scheduling restriction corresponding to a Layer 1 (L1) measurement of a reference signal associated with an L1 or Layer 2 (L1/L2) inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal; and
receiving the reference signal based at least in part on the measurement configuration.

101-150. (canceled)

151. A method of wireless communication performed by a network node, comprising:
transmitting a measurement configuration indicating a scheduling restriction corresponding to a Layer 1 (L1) measurement of a reference signal associated with an L1 or Layer 2 (L1/L2) inter-cell mobility operation associated with a first cell and a second cell, wherein the scheduling restriction prohibits communication of a signal, other than the reference signal, during at least one adjacent symbol, wherein the at least one adjacent symbol comprises at least one symbol that is adjacent to at least one measurement symbol associated with reception of the reference signal, and wherein the at least one adjacent symbol is not associated with reception of the reference signal; and
transmitting the reference signal based at least in part on the measurement configuration.

152-202. (canceled)
